(19) United States
(12) Patent Application Publication
(10) Pub. No.: US 2010/0201031 A1
(43) Pub. Date: Aug. 12, 2010

(54) MOLD FOR PRESS APPARATUS, AND OPEN-DRAWING METHOD

(75) Inventor: Masao Kubo, Aichi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/678,593

(22) PCT Filed: Nov. 11, 2008
(86) PCT No.: PCT/JP2008/070464

§ 371 Date: Mar. 17, 2010

(30) Foreign Application Priority Data
Nov. 30, 2007 (JP) 2007-310965

(51) Int. Cl. B29C 55/20

(52) U.S. Cl. 264/292; 425/112

(57) ABSTRACT

This aims to provide a press-apparatus mold capable of improving the yield of a blank while preventing wrinkles and cracks in a finished product, and an open-drawing method according to the press-apparatus mold. Within a range corresponding to the excess thickness portion (6) of a blank (4), the width of a punch (3) is gradually enlarged toward the end of the punch (3), thereby to curve boundaries (or the punch ridgelines (3d and 3e)) formed by the upper face (3a) and the side faces (3b and 3c) of the punch (3), toward the end of the punch (3) and to the widthwise outer sides of the punch (3). At the same time, the width of the recess (1a) of a die (1) is gradually enlarged toward the end of the recess (1a), thereby to curve a drawing profile (8) set by the punch (3) and the die (1), toward the ends of the punch (3) and the recess (1a) and to the widthwise outer sides of the punch (3) and the recess (1a).

### TECHNICAL FIELD

The present invention relates to a mold for a press apparatus and an open-drawing method.

### BACKGROUND ART

Conventionally, JP-8-25097-A discloses the art; in a corner portion of a cavity formed as a product shape, a gently projected or guttered portion is formed in the outside from the corner portion with some spans. When molding for deforming a blank, the compressive stress added to the blank is adjusted, thereby preventing wrinkles and cracks in the product.

However, the conventional art disclosed by JP-8-25097-A fails to limit the inflow of the blank from the open side of the mold, if the inflow of the blank, in the open-drawing, from the open side of the mold should be adjusted, it needs another means.

Conventionally, JP-1-197018-A alternatively discloses the art, the objective of which is to prevent wrinkles and cracks in the product.

In the conventional art disclosed by JP-1-197018-A, during the open-drawing, a work (the blank) is kept curved corresponding to a die (the mold), thereby preventing wrinkles and cracks in the pressed product.

However, the conventional art disclosed by JP-1-197018-A does not have the purpose of adjusting the deformation from the recess side of the mold positively, and it is difficult to prevent wrinkles and cracks caused by the over-inflow of the blank from the recess side of the mold.

Hereinafter, an embodiment of the conventional open-drawing is described.

A conventional mold 30 is described, with reference to FIG. 5.

For easily describing the following structure, in the direction of the standard axis in FIG. 5, the arrow X (the product longitudinal direction) shows forward, the arrow Y (the product width direction) shows rightward, the arrow Z (the product heightwise direction) shows upward.

As shown in FIG. 5, the mold 30 includes a die 31 as a cope, a blank holder 32, a punch 33 as a drag and so on.

The die 31 has a recess 31a on the bottom thereof in the downward and longitudinal directions including a bottom 31f, a left face 31g and a right face 31h. The die 31 has cushion faces 31b and 31c on the bottom thereof, and the recess 31a is formed between the faces. The faces 31b and 31c respectively have projected portions 31d and 31e, extending in the longitudinal direction, projecting downward on the faces 31b and 31c.

The holder 32 is formed with block portions 32a and 32b in the left and right of the holder and has the rectangular shape in plan; the portions 32a and 32b have cushion faces 32c and 32d on the top.

The faces 32c and 32d have guttered portions 32e and 32f formed on corresponding to the portions 31d and 31e, also extending in the longitudinal direction. Actually, the faces 32c and 32d of the holder 32 correspond to the faces 31b and 31c of the die 31, the face 31b contacts the face 32c, the face 31c contacts the face 32d.

The portions 2a and 2b have inside faces 2g and 2h, which form the space where the punch 3 is inserted. The distance between faces 2g and 2f is set where the punch 3 can be inserted and a blank 4 (see FIG. 6) can be deformed in the cavity 9.

The punch 33 has a upper face 33a formed on the top corresponding to the bottom face 31e of the die 31, also has side faces 33b and 33c formed on the left and right side corresponding to the faces 31g and 31h of the die 31.

A conventional open-drawing method using the mold 30 will described, with reference to FIG. 6.

A situation and a method of the setting the blank 34 to the mold 30 in the ready state will be described. Here, in FIG. 6(b), the mold 30 is described in plan with the perspective die 31 as a cope, the die 31 is not described (as the same as in FIGS. 2(b), 3(b), 4(b), 7(b), and 8(b)).

As shown in FIG. 6(a), when the blank 34 is set to the mold 30, the faces 32c and 32d of the holder 32 are kept upper than the face 33a of the punch 33, the blank 34 is set to the faces 32c and 32d of the holder 32. The die 31 is moved down and kept the position which the portions 31d and 31e of the die 31 are inserted to the portions 32e and 32f of the holder 32, the blank 34 is clamped by the portions 31d, 31e of the die 31 and the portions 32e, 32f of the holder 32.

Besides, in the mold 30, the position keeping the die 31, the height of the portion 31d and 31e and the depth of the portion 32e and 32f are adjusted respectively, thereby adjusting the clamping force for the blank 34 by the die 31 and the holder 32.

The mold 30 has a cavity 9 formed by the die 31, the holder 32 and the punch 33. The cavity 9 is formed as the desired product shape, the blank 34 is pressed along the cavity 39, the blank 34 becomes the product shape.

As shown in FIG. 6(b), in the typical press molding, the blank 34 has a parting line 35 set corresponding to the product form and the size thereof. The line 35 is a virtual borderline defining the remained area as the product and the cut area. The blank 34 has an excess thickness portion 36 set as the outside from the line 35. The portion 36 is cut finally and thus it is not the portion forming the product.

A drawing profile 38 is set as the border between faces 31g, 31h of the die 31 and faces 33b, 33c of the punch 33. The drawing profile comes out as the ridgeline in the corner of the finished product.

The areas X (the hatching areas in FIG. 6(b)) serve as clamp faces 37 constructed by the portions 31d, 31e and the portions 32e, 32f, and the faces 37 limit the movement and extension of the blank 4. Actually, the mold 30 can clamp the lateral ends of the blank 34, can not clamp the ends of the blank 34 in the recess side (the longitudinal ends).

The situation of the mold 30 and the blank 34 in the way of forming will described, with reference to FIG. 7.

As shown in FIG. 7(a), the die 31 and the holder 32 are moved down clamping the blank 34, thereby the ready state leads into the press molding state.

As the press molding is proceeding, the lateral ends of the blank 34 (the area A in FIG. 7(b)) clamped by the die 31 and the holder 32 is moved and stretched vertically to the ridgeline 33d and 33e and is deformed in the cavity 39. The blank 34 is clamped by the portions 31d, 31e and the portions 32e, 32f, so that the deformation of the lateral ends of the blank 34 in the cavity 39 is adjusted.

On the contrary, the recess side of the blank 4 (the area B in FIG. 7(b)) not clamped by the die 31 and the holder 32, is not directly clamped by the holder 32 and the punch 33, and is deformed in the cavity 9 in the direction parallel to the ridgeline 33d and 33e.

Adjusting the deformation amount of the blank 34 in the cavity 39 is difficult in the way of forming of the conventional press 30.

The situation of the mold 30 and the blank 34 in the finished forming will described, with reference to FIG. 8.

As shown in FIG. 8(a), when the die 31 and the holder 32 come to the bottom dead center, the blank 34 is press molded to the product shape by the recess 31a of the die 31 (faces 31f, 31g, 31h) and the face 33a, 33b, 33c of the punch 33.

When the die 31 and the holder 32 come to the bottom dead center, the lateral ends of the blank 34 (the area A in FIG. 7(b)) clamped by the die 31 and the holder 32 is moved and stretched vertically to the ridgeline 33d and 33e and is deformed in the cavity 39.

On the contrary, the recess side of the blank 34 (the area B in FIG. 7(b)) not clamped by the die 31 and the holder 32 is also clamped by the holder 32 and the punch 33, and is moved and stretched vertically to the ridgeline 33d and 33e, and is deformed in the cavity 39.

When the die 31 and the holder 32 come to the bottom dead center, the portion 36 of the recess side ends of the blank 34 can be clamped by the portion 31f of the die 31 and the face 33a of the punch 33.

Thus, the conventional mold 30 cannot adjust deformation amount of the recess side ends of the blank 34.

In the conventional open-drawing method using the mold 30, the blank 34 is deformed from the recess sides, so that the wrinkles 40 is generated inside of the parting line 35.

The parting line 35 may be set inside within the product, so that the portion 36 is extended and the loss of the blank 34 is increased, thereby the yield is decreased.

Conventionally, the open-drawing mold is not adopted, however, the press mold is adopted having the punch surrounded by the die and the blank holder, and the holding wrinkles face is formed around.

In this case, the deformation amount of the blank is adjusted rightly, but the excess thickness portion 36 clamped by the holding wrinkles face is set larger than the open-drawing mold, thereby the loss of blank 34 is increased and the yield is decreased.

The open-drawing method has advantage for improving the yield, so the open-drawing method capable of rightly adjusting the blank deformation from the recess side is desired.

### DISCLOSURE OF INVENTION

### Problems to Be Solved by the Invention

The objective of the present invention is to prevent wrinkles and cracks in the finished product and to improve the yield of the blank, providing the new mold for the press apparatus and the open-drawing method capable of adjusting the deformation amount of the blank from the recess of the mold in the way of forming.

### Means for Solving the Problems

The problem so as to be solved by the present invention are as mentioned above. Next, the means of solving the problem will be described.

The first aspect of the present invention is a mold which includes a die having cushion faces and a recess disposed in the longitudinal direction between the cushion faces, a blank holder for clamping a blank with the cushion faces and a punch formed with an upper face corresponding to a bottom of the recess and side faces corresponding to side faces of the recess, using an open-drawing forming.

In an embodiment of the mold according to the present invention, a width of the punch is gradually enlarged toward the longitudinal ends thereof in an area correspond to a excess thickness portion of the blank, and ridgelines formed between the upper face and side faces of the punch are curved to the outside of the punch width and to the longitudinal ends thereof.

In the alternative embodiment of the mold according to the present invention, the width of the punch is gradually enlarged toward the longitudinal ends thereof and the width of the recess of the die is gradually enlarged toward the longitudinal ends thereof in the area correspond to the excess thickness portion of the blank, and a drawing profile set by the punch and the die is curved to the outside of the punch width and the recess width and to the longitudinal ends thereof.

In the other mold according to the present invention, the width of the punch is gradually enlarged toward the longitudinal ends thereof in the area correspond to the excess thickness portion of the blank, and the ridgelines formed between the upper face and side faces of the punch are curved to the outside of the punch width and to the longitudinal ends thereof, and the recess width of the die is gradually enlarged toward the longitudinal ends thereof, and the drawing profile set by the punch and the die is curved to the outside of the punch width and the recess width and to the longitudinal ends thereof.

The second aspect of the present invention is an open-drawing method using the mold comprising the die having cushion faces and the recess disposed in the longitudinal direction between the cushion faces, the blank holder for clamping the blank with the cushion faces and the punch formed with the upper face corresponding to the bottom of the recess and side faces corresponding to side faces of the recess, the die, the blank holder, and the punch forms a cavity as a product shape.

In an embodiment of the open-drawing method according to the present invention, the punch is provided with a width enlarged portion toward the longitudinal ends thereof and with the curved ridgelines formed between the upper face and side faces of the punch to the outside of the punch width and to the longitudinal ends thereof in the area correspond to the excess thickness portion of the blank, the blank in the cavity is deformed along the ridgelines, and the excess thickness portion is curved to the outside of the punch width and to the longitudinal ends thereof.

In the alternative embodiment of the open-drawing method according to the present invention, the punch is provided with the width enlarged portion toward the longitudinal ends thereof, with the width enlarged portion of recess of the die toward the longitudinal ends thereof and with the curved drawing profile set the punch and the die to the outside of the punch width and recess width and to the longitudinal ends thereof in the area correspond to the excess thickness portion of the blank, and the blank is curved along the drawing profile by the die, and the excess thickness portion is curved to the outside of the punch and recess widths and to the longitudinal ends thereof.

In the advantageous embodiment of the open-drawing method according to the present invention, the punch is provided with the width enlarged portion toward the longitudinal ends thereof, with the curved ridgelines formed between the upper face and side faces of the punch to the outside of the punch width and to the longitudinal ends thereof in an area correspond to the excess thickness portion of the blank, and the blank is deformed in the cavity along the ridgelines, and the die is provided with the width enlarged portion of recess of the die toward the longitudinal ends thereof and with the curved the drawing profile set the punch and the die to the outside of the punch width and recess width and to the longitudinal ends thereof, and the blank is curved along the drawing profile by the die, and the excess thickness portion is curved to the outside of the punch width and recess width and to the longitudinal ends thereof.

### Effects of the Invention

The present invention shows the following effects.

According to the present invention, the tension exerted to the outside of the recess is certainly added to the blank and the deformation amount of the blank into the cavity from the recess side of the mold is properly adjusted, thereby preventing the wrinkles and cracks in the finished product.

### BRIEF DESCRIPTION OF DRAWING

FIG. 1 is a perspective view showing a whole of a mold for a press apparatus.

FIG. 2 is a view showing a situation of the press forming (in the ready of forming) by an open-drawing method as an embodiment of the present invention, FIG. 2(a) is a front section view, FIG. 2(b) is a partial plan view.

FIG. 3 is a view showing a situation of the press forming (in the way of forming) by the open-drawing method as the embodiment of the present invention, FIG. 3(a) is a front section view, FIG. 3(b) is a partial plan view.

FIG. 4 is a view showing a situation of the press forming (in the finished of forming) by the open-drawing method as the embodiment of the present invention, FIG. 4(a) is a front section view, FIG. 4(b) is a partial plan view.

FIG. 5 is a perspective view showing a whole of a conventional mold for a press apparatus.

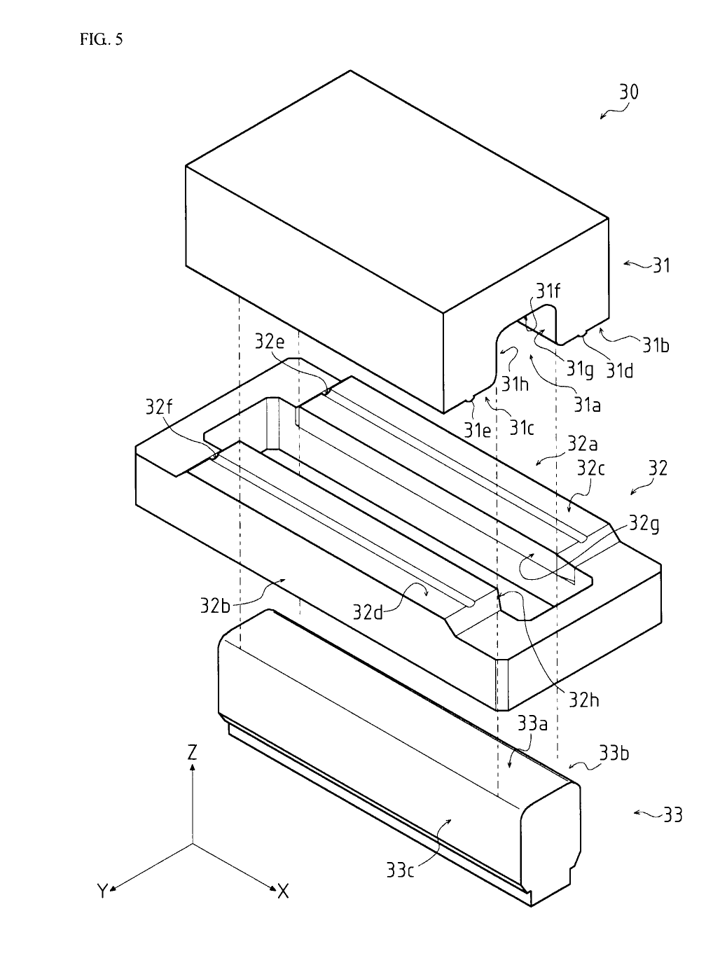

FIG. 6 is a view showing a situation of the press forming (in the ready of forming) by a conventional open-drawing method, FIG. 6(a) is a front section view, FIG. 6(b) is a partial plan view.

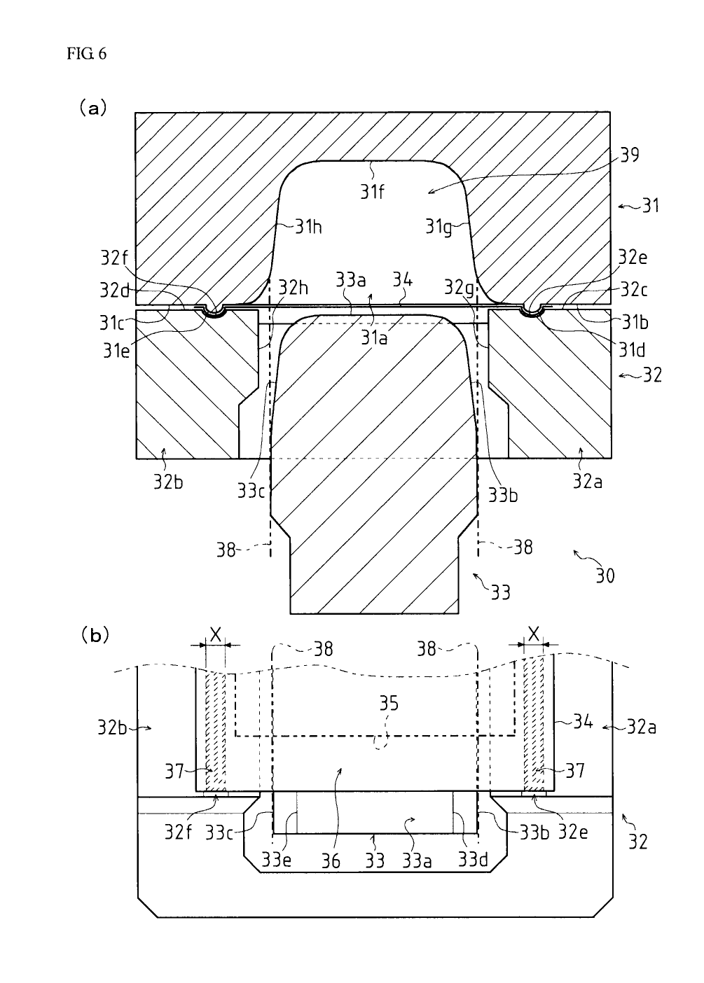

FIG. 7 is a view showing a situation of the press forming (in the way of forming) by the conventional open-drawing method, FIG. 7(a) is a front section view, FIG. 7(b) is a partial plan view.

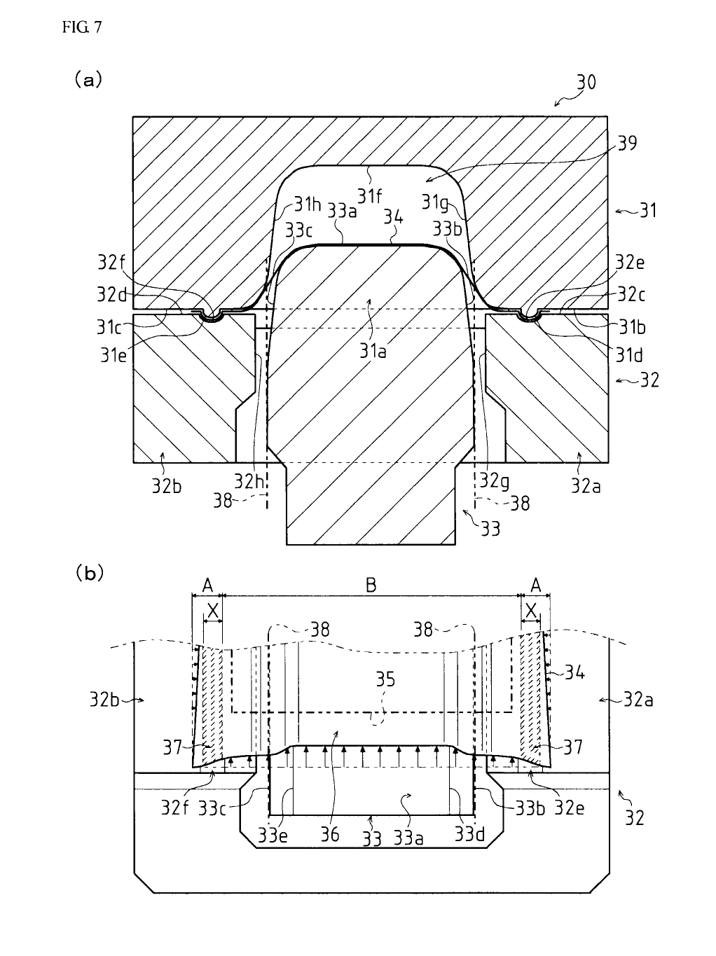

FIG. 8 is a view showing a situation of the press forming (in the finished of forming) by the conventional open-drawing method, FIG. 8(a) is a front section view, FIG. 8(b) is a partial plan view.

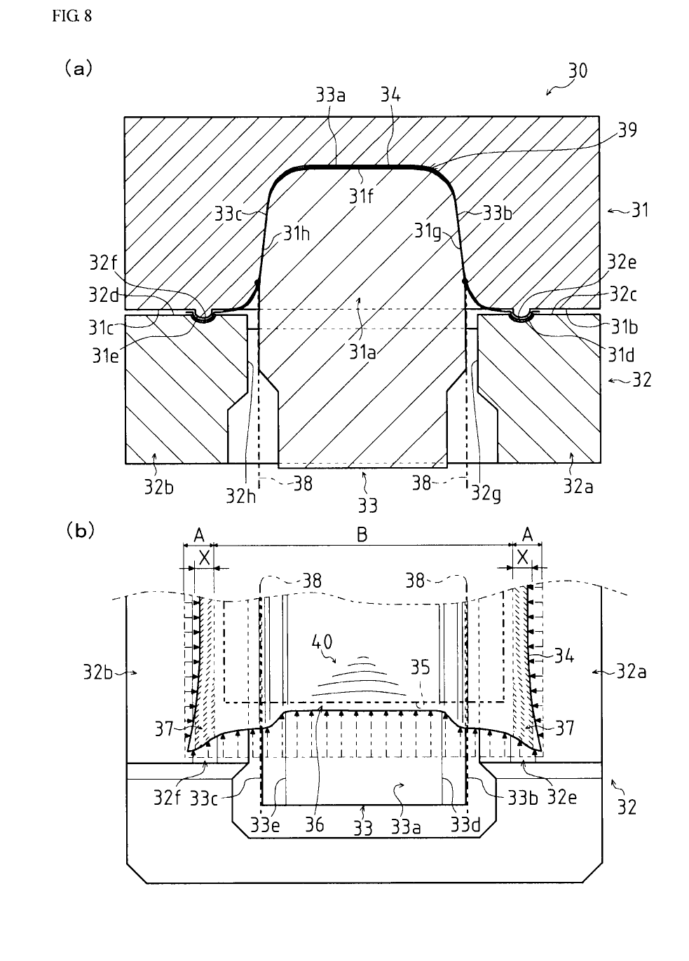

### THE BEST MODE FOR CARRYING OUT THE INVENTION

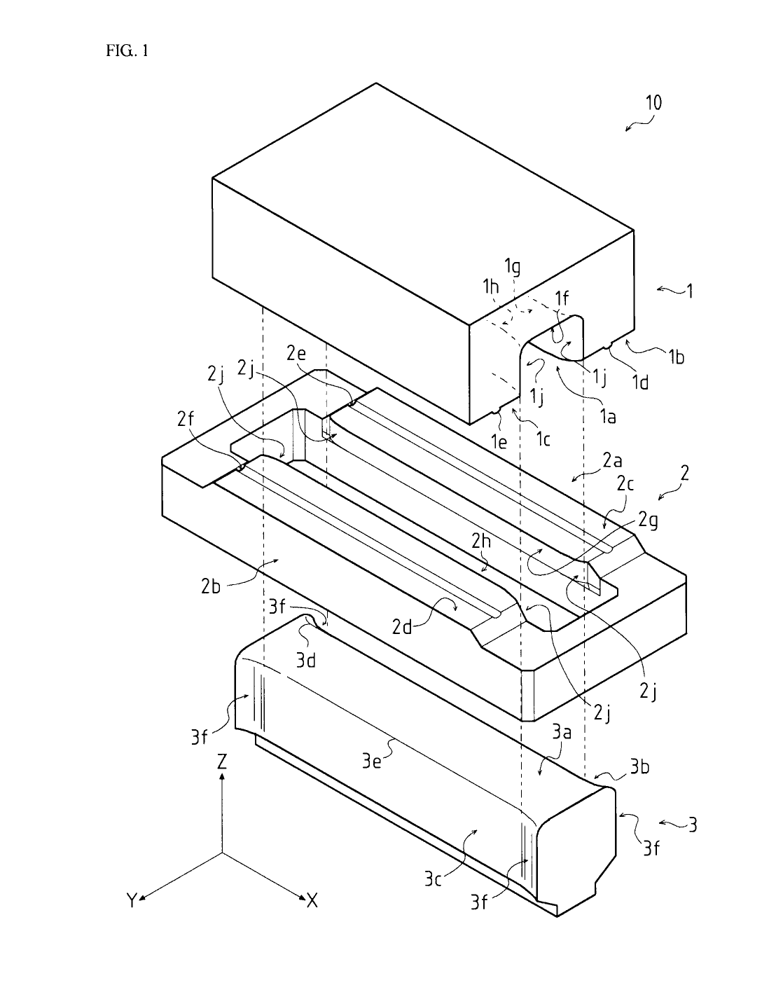

A mold 10 for a press apparatus will be described with reference to FIG. 1.

For the following structure will be described easily, in the direction of the standard axis in FIG. 1, the arrow X (the product longitudinal direction) shows forward, the arrow Y (the product width direction) shows rightward, the arrow Z (the product heightwise direction) shows upward.

The standard axis is set described easily, does not especially limited to arranged components (a die, a blank holder, a punch, and so on) of the mold.

As shown in FIG. 1, the mold 10 includes a die 1 as a cope, a blank holder 2, a punch 3 as a drag and so on.

The die 1 has a recess 1a on the bottom thereof including a bottom 1f, a left face 1g and a right face 1h, and the die has the recess in the downward and longitudinal directions. The die 1 has cushion faces 1b and 1c on the bottom thereof, and the recess 1a is formed between the faces. The faces 1b and 1c respectively have projected portions 1d and 1e, extending in the longitudinal direction, projecting downward on the faces 1b and 1c.

The die 1 has curved portions 1j formed at the longitudinal ends of faces 1g and 1h, curved to the outside in the direction of the axis Y (the product width direction), and in this point it is different from the conventional die 31.

The holder 2 is formed with block portions 2a and 2b in the left and right of the holder and has the rectangular shape in plan; the portions 2a and 2b have cushion faces 2c and 2d on the top.

The faces 2c and 2d have guttered portions 2e and 2f formed on corresponding to the portions 1d and 1e, also extending in the longitudinal direction. Actually, the faces 2c and 2d of the holder 2 correspond to the faces 1b and 1c of the die 1, the face 1b contacts the face 2c, the face 1c contacts the face 2d.

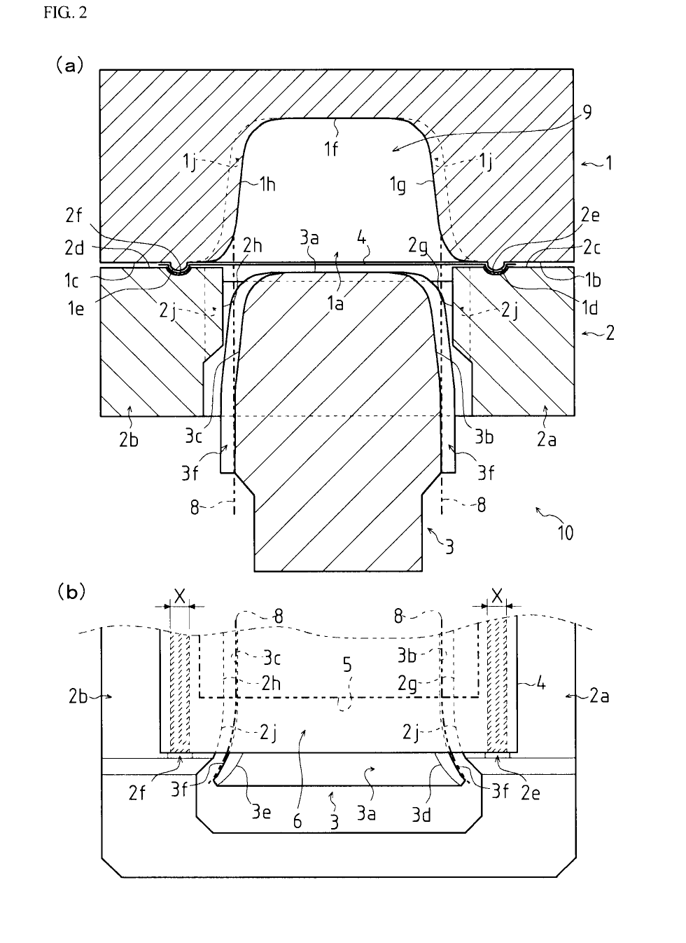

The portions 2a and 2b have inside faces 2g and 2h, which form the space where the punch 3 is inserted. The distance between faces 2g and 2f is set where the punch 3 can be inserted and a blank 4 (see FIG. 2) can be deformed.

The holder 2 has curved portions 2j formed at the longitudinal ends of faces 2g and 2h corresponding to the portions 1j of the die 1, curved to the outside in the direction of the axis Y (the product width direction), and in this point it is different from the conventional holder 32.

The punch 3 has a upper face 3a formed on the top corresponding to the bottom face 1e of the die 1, also has side faces 3b and 3c formed on the left and right side corresponding to the faces 1g and 1h of the die 1.

The punch 3 has curved portions 3f formed at the longitudinal ends of faces 3b and 3c corresponding to the portions 1j of the die 1 and portions 2j of the holder 2, curved to the outside in the axis Y (the product width direction).

The punch 3 has a ridgeline 3d (borderline between faces 3a and 3b), a ridgeline 3e (borderline between faces 3b and 3c), and thus, they and a drawing profile 8 are curved to the outside in the axis Y (the product width direction).

An open-drawing method using the mold 10 will described, with reference to FIG. 2.

A situation and a method of the setting the blank 4 to the mold 10 in the ready state will be described.

As shown in FIG. 2(a), when the blank 4 is set to the mold 10, the faces 2c and 2d of the holder 2 are kept upper than the face 3a of the punch 3, the blank 4 is set to the faces 2c and 2d of the holder 2. The die 1 is moved down and kept the position which the portions 1d and 1e of the die 1 are inserted to the portions 2e and 2f of the holder 2, the blank 4 is clamped by the portions 1d, 1e of the die 1 and the portions 2e, 2f of the holder 2.

Besides, in the mold 10, the position keeping the die 1, the height of the portion 1d and 1e and the depth of the portion 2e and 2f are adjusted respectively, thereby adjusting the clamping force for the blank 4 by the die 1 and the holder 2.

The mold 10 has a cavity 9 as the product shape formed by the die 1, holder 2 and punch 3.

As shown in FIG. 2(b), in the open-drawing method, the blank 4 has a parting line 5 set corresponding to the product form and the size thereof. The blank 4 has a excess thickness portion 6 set as the outside from the line 5.

The drawing profile 8 is set as the border line between faces 1g, 1h of the die 1 and faces 3b, 3c of the punch 3.

The areas X (the broken line hatching areas in FIG. 2(b)) serve as clamp faces 7 constructed by the portions 1d, 1e and the portions 2e, 2f, and the faces 7 adjust the movement and extension of the blank 4. Actually, the mold 10 can clamp the lateral ends of the blank 4, can not clamp the ends of the blank 4 in the recess side (the longitudinal ends).

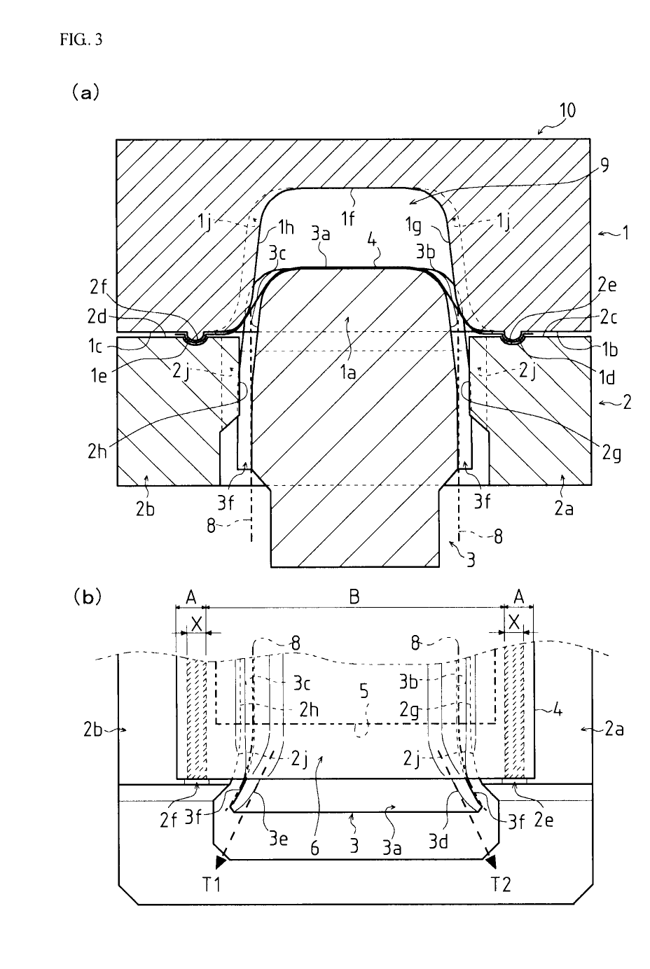

The situation of the mold 10 and the blank 4 in the way of forming will described, with reference to FIG. 3.

As shown in FIG. 3(a), the die 1 and holder 2 are moved down clamping the blank 4, the ready state proceeds to the press molding state.

As the press molding is proceeding, the lateral ends of the blank 4 (the area A in FIG. 3(b)) clamped by the die 1 and holder 2 is moved and stretched vertically to the ridgeline 3d and 3e and is deformed in the cavity 9. The blank 4 is clamped by the portions 1d, 1e and the portions 2e, 2f, so that the deformation amount of the lateral ends of the blank 4 in the cavity 9 is adjusted.

On the contrary, the excess thickness portion 6 of the recess side of the blank 4 (the area B in FIG. 3(b)) not clamped by the die 1 and holder 2 is deformed in the cavity 9 curving along the ridgeline 3d and 3e which curve to the outer direction of Y axis (the product width direction). Here, as the blank 4 is curved along the ridgeline 3d and 3e, the tension is added to the blank 4, exerted to the recess side (in the longitudinal direction, for example the direction showed by the arrow T1 and T2 in FIG. 3(b)).

The tension is generated by deforming the portion 6 into the cavity 9 curving along the ridgelines 3d and 3e, and it should be noted that if the portions 1j are not formed in the die 1, the tension may be exerted.

As an embodiment of the present invention, the mold 10 includes the die 1 having faces 1b, 1c and an recess 1a disposed in the longitudinal direction between the faces 1b and 1c, the holder 2 for clamping the blank 4 with the faces 1b, 1c and the punch 3 formed with the face 3a corresponding to the bottom 1f of the recess 1a and faces 3b, 3c corresponding to faces 1g, 1h of the recess 1a, in which the width of the punch 3 is gradually enlarged toward the longitudinal ends thereof in the area correspond to the portion 6 of the blank 4, and in which the borderline (the ridgelines 3d, 3e) formed between the face 3a, 3b, 3c of the punch 3 are curved to the outside of the punch width and to the longitudinal ends thereof.

As an embodiment of the present invention, the open-drawing method using the mold 10 including the die 1 having faces 1b, 1c and the recess 1a disposed in the longitudinal direction between the faces 1b and 1c, the holder 2 for clamping the blank 4 with the faces 1b, 1c and the punch 3 formed with the face 3a corresponding to the bottom 1f of the recess 1a and faces 3b, 3c corresponding to faces 1g, 1h of the recess 1a, the die 3, the blank holder 2, and the punch 3 forms the cavity 9 as the product shape, providing the punch 3 with a width enlarged portion toward the longitudinal ends thereof and with curved ridgelines 3d, 3e formed between the face 3a, 3b, 3c of the punch 3 to the outside of the punch width and to the longitudinal ends thereof in the area correspond to the portion 6 of the blank 4, deforming the blank 4 in the cavity 9 along the ridgelines 3d and 3e, curving the portion 6 to the outside of the punch width and to the longitudinal ends thereof.

Due to the above structure, the tension exerted to the outside of the recess is certainly added to the blank 4 and the deformation amount of the blank 4 into the cavity 9 from the recess side of the mold 10 is properly adjusted, thereby preventing the wrinkles and cracks in the finished product.

At the same time the blank 4 is curved along the ridgelines 3d and 3e, the portion 6 is curved along the portions 1j (the drawing profile 8), so that the tension is added to the blank 4, exerted to the recess side (in the longitudinal direction, for example the direction showed by the arrow T1 and T2 in FIG. 3(b)).

The portion 6 is curved along the portions 1j (the drawing profile 8), the tension is added, and it should be noted that if the portions 1j are not formed in the die 1, the tension may be exerted.

As an embodiment of the present invention, the mold 10 includes the die 1 having faces 1b, 1c and the recess 1a disposed in the longitudinal direction between the faces 1b and 1c, the holder 2 for clamping the blank 4 with the faces 1b, 1c and the punch 3 formed with the face 3a corresponding to the bottom 1f of the recess 1a and faces 3b, 3c corresponding to faces 1g, 1h of the recess 1a, in which the width of the punch 3 is gradually enlarged toward the longitudinal ends thereof and the width of the recess 1a of the die 1 is gradually enlarged toward the longitudinal ends thereof in the area correspond to portion 6 of the blank 4, in which the profile 8 set by the punch 3 and the die 1 is curved to the outside of the punch width and the recess widths and to the longitudinal ends thereof.

As an embodiment of the present invention, the open-drawing method using the mold 10 including the die 1 having faces 1b, 1c and the recess 1a disposed in the longitudinal direction between the faces 1b and 1c, the holder 2 for clamping the blank 4 with the faces 1b, 1c and the punch 3 formed with the face 3a corresponding to the bottom 1f of the recess 1a and faces 3b, 3c corresponding to faces 1g, 1h of the recess 1a, the die 3, the blank holder 2, and the punch 3 forms the cavity 9 as the product shape, providing the punch 3 with a width enlarged portion toward the longitudinal ends thereof and with a curved ridgelines 3d, 3e formed between the face 3a, 3d, 3e of the punch 3 to the outside of the punch width and to the longitudinal ends thereof in the area correspond to the portion 6 of the blank 4, deforming the blank 4 in the cavity 9 along the ridgelines 3d, 3e, curving the 6 to the outside of the punch width and to the longitudinal ends thereof.

Due to the above structure, the tension exerted to the outside of the recess is certainly added to the blank 4 and the deformation amount of the blank 4 into the cavity 9 from the recess side of the mold 10 is properly adjusted, thereby preventing the wrinkles and cracks in the finished product.

When the blank is came contact with the ridgelines 3d, 3e (in the start of the open-drawing forming), the tension can be added to the blank exerting to the recess (in the longitudinal direction). In other words, as an embodiment of the present invention, in the press 10 and open-drawing method using the mold 10, the timing is not generated when the blank 4 in the recess side (the area A in FIG. 3(b)) is deformed in the cavity 9 not clamped by the die 1 and the holder 3.

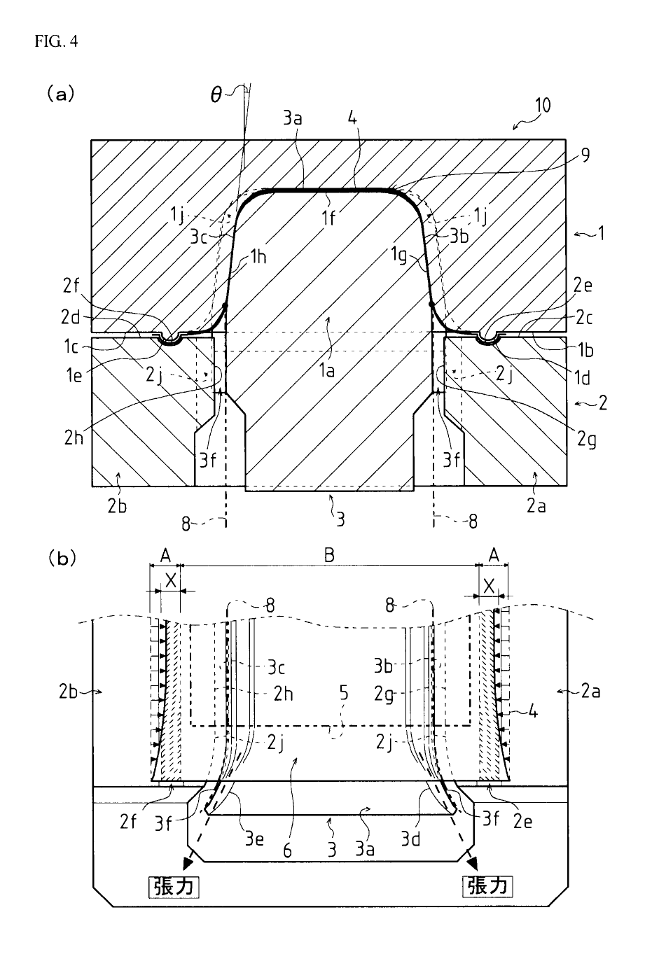

The situation of the mold 10 and the blank 4 in the finished forming will described, with reference to FIG. 4.

As shown in FIG. 4(a), when the die 1 and holder 2 come to the bottom dead center, the lateral ends of the blank 4 (the area A in FIG. 4(b)) clamped by the die 1 and holder 2 is moved and stretched vertically to the ridgeline 3d and 3e and is deformed in the cavity 9.

On the contrary, the recess sides of the blank 4 (the area B in FIG. 4(b)) not clamped by the die 1 and holder 2 is deformed in the cavity 9 curving along the ridgeline 3d and 3e, is curved along to the curved portion 1j (the drawing profile 8), so that the fitting tension is added to the blank 4, exerted to the recess sides (in the longitudinal direction, for example the direction showed by the arrow T3 and T4 in FIG. 4(b)), thereby the deformation of the blank is limited.

As an embodiment of the present invention, the mold 10 includes the die 1 having faces 1b, 1c and the recess 1a disposed in the longitudinal direction between the faces 1b and 1c, the holder 2 for clamping the blank 4 with the faces 1b, 1c and the punch 3 formed with the face 3a corresponding to the bottom 1f of the recess 1a and faces 3b, 3c corresponding to side faces 1g, 1h of the recess 1a, in which the width of the punch 3 is gradually enlarged toward the longitudinal ends thereof in the area correspond to the portion 6 of the blank 4, in which the ridgelines 3d, 3e formed between the face 3a, 3b, 3c of the punch 3 are curved to the outside of the punch width and to the longitudinal ends thereof, in which the recess width of the die 1 is gradually enlarged toward the longitudinal ends thereof, in which the profile 8 set by the punch 3 and the die 1 is curved to the outside of the punch width and the recess width and to the longitudinal ends thereof.

As an embodiment of the present invention, the open-drawing method using the mold 10 including the die 1 having the faces 1b, 1c and the recess 1a disposed in the longitudinal direction between the faces 1b and 1c, the holder 2 for clamping the blank 4 with the faces 1b, 1c and the punch 3 formed with the face 3a corresponding to the bottom 1f of the recess 1a and the faces 3b, 3c corresponding to the faces 1g, 1h of the recess 1a, the die 1, the holder 2, and the punch 3 forms the cavity 9 as the product shape, providing the punch 3 with the width enlarged portion toward the longitudinal ends thereof and with curved ridgelines 3d, 3e formed between the face 3a, 3b, 3c of the punch 3 to the outside of the punch width and to the longitudinal ends thereof in the area correspond to the portion 6 of the blank 4, deforming the blank 4 in the cavity 9 along the ridgelines 3d, 3e, providing the die 1 with the width enlarged portion of recess toward the longitudinal ends thereof and with the curved portion of the profile 8 set the punch 3 and the die 1 to the outside of the punch width and recess width and to the longitudinal ends thereof, curving the blank 4 along the profile 8 by the die 1, curving the portion 6 to the outside of the punch width and recess width and to the longitudinal ends thereof.

Due to the above structure, the tension is generated synergistically when the portion 6 is curved along the ridgelines 3d, 3e and is curved by the die 1 along the portion 1j thereof, so that the tension exerted to the outside of the recess is certainly added to the blank 4 and the deformation amount of the blank 4 into the cavity 9 from the recess side of the mold 10 is properly adjusted, thereby preventing the wrinkles and cracks in the finished product.

In the open-drawing method as an embodiment of the present invention, the portion 6 in the recess side and the ends of the blank 4 are clamped in the way of forming, when the die 1 and holder 2 do not come to the bottom dead center, the deformation amount of the portion 6 in the recess side and the ends of the blank 4 can be limited. Thus, the portion 6 is not set larger, the blank 4 in the recess side can be limited.

In the open-drawing method using the press 10, the wrinkles are not occurred by the deformation of the blank 4 in the recess side unlike the conventional press 30. The portion 6 can be set smaller, thereby improving the yield.

Beside, if the curvature of the portion 1j of the die 1 and portion 3f of the punch 3 in plane is lower, the tension exerted to the longitudinal finished product is higher.

The deformation of the blank 4 in the cavity 9 is adjusted by changing the curvature of the portion 1j, 3f in plane, so that the deformation of the blank 4 is fine tuned easily by amending the mold.

If the longitudinal fall angle of the portion 6 (the angle θ in FIG. 4) in the outside of the line 5 is set narrower, the tension exerted to the recess side of the blank 4 (in the direction of the longitudinal finished product) is lower.

### INDUSTRIAL APPLICABILITY

The present invention is applicable in the industrial instrument as the mold for the press apparatus and the open-drawing method using the mold, is also applicable to the mold and the method without the recess.

1. A mold comprising:
a die having cushion faces and a recess disposed in a longitudinal direction between the cushion faces;
a blank holder for clamping a blank with the cushion faces; and
a punch formed with an upper face corresponding to a bottom of the recess and side faces corresponding to side faces of the recess,
wherein a width of the punch is gradually enlarged toward a longitudinal ends thereof in an area correspond to a excess thickness portion of the blank, and
wherein ridgelines formed between the upper face and side faces of the punch are curved to the outside of the punch width and to the longitudinal ends thereof.

2. A mold comprising:
a die having cushion faces and a recess disposed in a longitudinal direction between the cushion faces;
a blank holder for clamping a blank with the cushion faces; and
a punch formed with an upper face corresponding to a bottom of the recess and side faces corresponding to side faces of the recess,
wherein a width of the punch is gradually enlarged toward a longitudinal ends thereof and a width of the recess of the die is gradually enlarged toward the longitudinal ends thereof in an area correspond to a excess thickness portion of the blank, and
wherein a drawing profile set by the punch and the die is curved to the outside of the punch width and the recess widths and to the longitudinal ends thereof.

3. A mold comprising:
a die having cushion faces and a recess disposed in a longitudinal direction between the cushion faces;
a blank holder for clamping a blank with the cushion faces; and
a punch formed with an upper face corresponding to a bottom of the recess and side faces corresponding to side faces of the recess,
wherein a width of the punch is gradually enlarged toward a longitudinal ends thereof in an area correspond to a excess thickness portion of the blank,
wherein ridgelines formed between the upper face and side faces of the punch are curved to the outside of the punch width and to a longitudinal ends thereof,
wherein a recess width of the die is gradually enlarged toward the longitudinal ends thereof, and
wherein a drawing profile set by the punch and the die is curved to the outside of the punch width and the recess width and to the longitudinal ends thereof.

4. An open-drawing method using a mold comprising: a die having cushion faces and a recess disposed in a longitudinal direction between the cushion faces; a blank holder for clamping a blank with the cushion faces; and a punch formed with an upper face corresponding to a bottom of the recess and side faces corresponding to side faces of the recess, the die, the blank holder and the punch forms a cavity as a product shape, the method comprising:
providing the punch with a width enlarged portion toward a longitudinal ends thereof and with curved ridgelines formed between the upper face and the side faces of the punch to the outside of the punch width and to the longitudinal ends thereof in an area correspond to an excess thickness portion of the blank;
deforming the blank in the cavity along the ridgelines; and
curving the excess thickness portion to the outside of the punch width and to the longitudinal ends thereof.

5. An open-drawing method using a mold comprising a die having cushion faces and a recess disposed in a longitudinal direction between the cushion faces, a blank holder for clamping a blank with the cushion faces and a punch formed with an upper face corresponding to a bottom 1f of the recess and side faces corresponding to side faces of the recess, the die, the blank holder, and the punch forms a cavity as a product shape, the method comprising:
providing the punch with a width enlarged portion toward a longitudinal ends thereof, with a width enlarged portion of recess of the die toward the longitudinal ends thereof and with a curved drawing profile set by the punch and the die to the outside of the punch wide and recess width and to the longitudinal ends thereof in an area correspond to a excess thickness portion of the blank;
curving the blank along the drawing profile by the die; and
curving the excess thickness portion to the outside of the punch width and recess width and to the longitudinal ends thereof.

6. An open-drawing method using a mold comprising a die having cushion faces and a recess disposed in a longitudinal direction between the cushion faces a blank holder for clamping a blank with the cushion faces and a punch formed with an upper face corresponding to a bottom of the recess and side faces corresponding to side faces of the recess, the die, the blank holder, and the punch forms a cavity as a product shape, the method comprising:
providing the punch with a width enlarged portion toward a longitudinal ends thereof and with curved ridgelines formed between the upper face and the side faces of the punch to the outside of the punch width and to the longitudinal ends thereof in an area correspond to an excess thickness portion of the blank;
deforming the blank in the cavity along the ridgelines;
providing the die with a width enlarged portion of recess toward the longitudinal ends thereof and with a curved drawing profile set the punch and the die to the outside of the punch width and recess width and to the longitudinal ends thereof;
curving the blank along the drawing profile by the die; and
curving the excess thickness portion to the outside of the punch width and recess width and to the longitudinal ends thereof.
